(19) United States
(12) Patent Application Publication
(10) Pub. No.: US 2017/0310163 A1
(43) Pub. Date: Oct. 26, 2017

(54) Wireless Power Transmission for a Smart Multi-Cage Data Acquisition System with Distributed Implants

(71) Applicant: Georgia Tech Research Corporation, Atlanta, GA (US)

(72) Inventors: Maysam Ghovanloo, Atlanta, GA (US); Seyedabdollah Mirbozorgi, Atlanta, GA (US)

(21) Appl. No.: 15/493,457

(22) Filed: Apr. 21, 2017

Related U.S. Application Data
(60) Provisional application No. 62/326,097, filed on Apr. 22, 2016.

(51) Int. Cl. H02J 50/12; H02J 50/80; A01K 1/00; A01K 29/00

(52) U.S. Cl. CPC H02J 50/12; A01K 29/005; H02J 50/80; A01K 1/00

(57) ABSTRACT

A homecage system for facilitating an experiment using an animal includes a cage unit configured to hold the animal therein. A misalignment insensitive transmitting resonant wireless power transfer unit encompasses the cage unit. The transmitting resonant wireless power transfer unit is configured to be driven by an external power signal so as to generate a radio frequency wireless power transfer signal. A headstage unit is configured to be physically coupled to the animal and is responsive to the wireless power transfer signal. The headstage unit transmits data wirelessly from a sensor associated with the animal. A control unit is in data communication with the headstage unit and controls the external power signal. A remote unit is in data communication with the control unit. The remote unit transmits control information thereto and that communicates data via a local area network.

### CROSS-REFERENCE TO RELATED APPLICATION(S)

This application claims the benefit of U.S. Provisional Patent Application Ser. No. 62/326,097, filed Apr. 22, 2016, the entirety of which is hereby incorporated herein by reference.

### STATEMENT OF GOVERNMENT INTEREST

This invention was made with government support under agreement No. ECCS-1407880, awarded by the National Science Foundation and under agreement No. R21EB018561, awarded by the National Institutes of Health. The government has certain rights in the invention.

### BACKGROUND OF THE INVENTION

### 1. Field of the Invention

The present invention relates to a homecage system for facilitating experiments with animals and, more specifically, to a homecage system that employs misalignment-insensitive wireless power transfer to deliver power to electronic devices implanted in or attached to animal body.

### 2. Description of the Related Art

Many of today's basic science and preclinical research experiments are conducted on small vertebrates, such as rodents. According to one estimate, in 2001, about 80 million mice and rats were used for animal experiments in the U.S. alone. A significant number of these experiments are conducted on awake behaving animal subjects to control the variables that affect the behavior or biological system under study. They often require detailed preparations to monitor vital signs, behaviors, phenotypes, and physiological parameters with sensors that are either installed around the experimental arena or attached to or implanted in the animal body. There are also in vivo experiments that involve interventions, such as stimulation or drug delivery, which follow a similar routine after the surgical procedure for sensor, electrode, actuator, or conduit placement.

A common experimental routine includes the following steps: 1) transfer the animal subjects from their homecage in the animal facility to the experimental arena; 2) attach cables, connectors, reservoirs, or wireless modules; 3) closely observe the animal behavior during the training or data collection period; 4) detach everything from the animal; and 5) return the animal back to the homecage in the animal facility. This routine needs to be repeated for every session and every subject, which creates a stressful environment for the animal subjects that can bias their behavior and experimental results. It is also quite labor intensive and time consuming for the researchers in long-term experiments, and it imposes significant financial burden on the research institutions.

Similarly, testing early stage new drugs or medical devices under development in terms of efficacy, safety, reliability, and biocompatibility, involves experiments that run over extended periods in large animal subject populations to achieve reliable and meaningful statistical outcomes. Shortening any portion of the aforementioned procedure can have a significant impact on the quality of the experimental results and reduction in costs and labor.

In experiments in which electrical power must be applied to sensors affixed to or implanted in the animal's body and in which data must be taken from the animal (such as experiments involving neural implants) cumbersome wires are often attached to a sensor pack (referred to as a “headstage”) that is affixed to or implanted in the animal's body. These wires limit the animal's movement, which can affect the results of the experiment, and can make visual observation of the animal more difficult.

There are several systems that apply power wirelessly by embedding wireless power transfer coils in the homecage and then affixing a receiving coil to the animal. Such systems employ a large radio frequency (RF) cavity under the homecage, the placement of which can prevent return of the homecage to a storage rack in a laboratory. Such RF systems tend to be limited as to the amount of power they can use for safety reasons due to a high rate of electromagnetic field absorption in the water at high frequency. Also, such systems can experience varying power levels as a result of misalignment between the headstage and the RF cavity that can occur as the animal moves about the cage.

Therefore, there is a need for a homecage system that applies power consistently, irrespective of the animal's position.

### SUMMARY OF THE INVENTION

The disadvantages of the prior art are overcome by the present invention which, in one aspect, is a homecage system for facilitating an experiment using an animal that includes a cage unit configured to hold the animal therein. A misalignment insensitive transmitting resonant wireless power transfer unit encompasses the cage unit. The transmitting resonant wireless power transfer unit is configured to be driven by an external power signal so as to generate a radio frequency wireless power transfer signal. A headstage unit is configured to be physically coupled to the animal and is responsive to the wireless power transfer signal. The headstage unit transmits data wirelessly from a sensor associated with the animal. A control unit is in data communication with the headstage unit and controls the external power signal. A remote unit is in data communication with the control unit. The remote unit transmits control information thereto and that communicates data via a local area network.

In another aspect, the invention is a homecage that includes a cage unit configured to hold the animal therein. A misalignment insensitive transmitting resonant wireless power transfer unit encompasses the cage unit and is configured to be driven by an external power signal so as to generate a wireless power transfer signal. The misalignment insensitive transmitting resonant wireless power transfer unit includes a primary coil, having a resonant radio frequency, directly driven by the control unit so as to oscillate at the resonant radio frequency. A plurality of primary resonator coils is electrically isolated from the primary coil and is in magnetic resonance with the primary coil. Each of the plurality of primary resonator coils is affixed to a portion of the cage unit and aligned with a different plane so that no two of the plurality of primary resonator coils are co-planar. A control unit controls the external power signal.

In yet another aspect, the invention is a method of controlling an experiment with an animal in which a headstage unit is affixed to the animal and the animal is placed in a cage. The headstage unit is powered with a misalignment insensitive transmitting resonant wireless power transfer unit that encompasses the cage. Data is collected from the headstage unit with a wireless device.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a schematic diagram showing one embodiment of a homecage system.

FIGS. 2A-2D are different views of one embodiment of a homecage.

FIG. 3 is a flow chart showing data flow between a driver and a headstage.

FIG. 4 is a circuit diagram showing an equivalent circuit for one embodiment of a homecage system.

FIG. 5 is a schematic diagram of a floating implant that employs wireless power transfer.

FIG. 6 is a schematic diagram of a plurality of floating implants in use.

FIG. 7 is a schematic diagram of a multiple floating implant system.

FIG. 8 is a circuit diagram showing an equivalent circuit for one embodiment of a floating implant system.

FIG. 9 is a chart showing wireless power transfer efficiency.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

In the several of the drawings different line patterns were used to make differentiating the coils easier. There is no technological significance to the specific line patterns used.

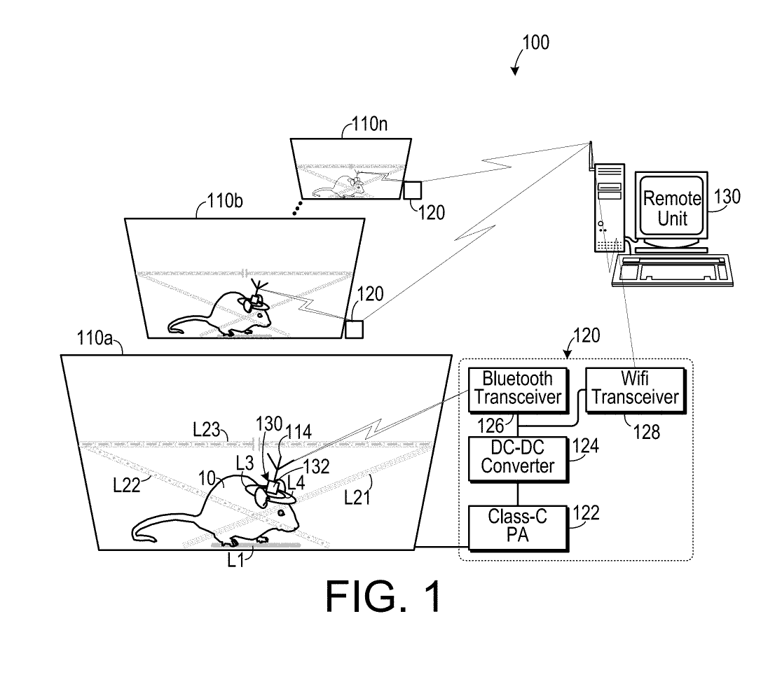

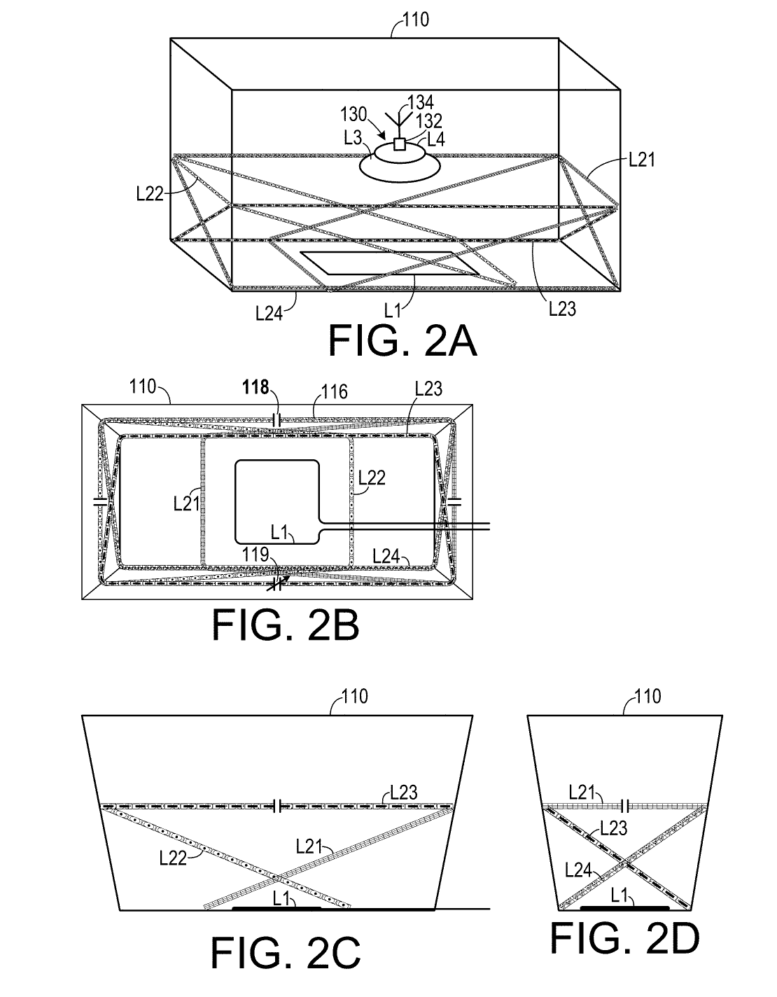

As shown in FIG. 1 and FIGS. 2A-2D, one embodiment of a homecage system 100 for facilitating an experiment using an animal 10 includes a cage unit 110 (which could be one of several cage units 110a-100n in a multi-homecage system) that holds the animal 10 therein. The cage unit 110 could be of the type of a standard laboratory homecage. The system 100 includes a misalignment insensitive transmitting resonant wireless power transfer unit driven by a control unit 120. The misalignment insensitive transmitting resonant wireless power transfer unit encompasses the cage unit and includes a primary coil L1 that has a resonant radio frequency, directly driven by the control unit 120 so as to oscillate at the resonant radio frequency. A plurality of primary resonator coils L21-L24 are electrically isolated from the primary coil L1 and from each other. The primary resonator coils L21-L24 are in magnetic resonance with the primary coil L1. Each of the primary resonator coils L21-L24 is affixed to a portion of the cage unit 110 and is aligned along a different plane so that no two of the plurality of primary resonator coils L21-L24 are co-planar. Each of the plurality of primary resonator coils L21-L24 includes a conductive member 116 that has a first end and an opposite second end. A terminating capacitor 118 that couples the first end to the second end. In one embodiment, at least one terminating capacitor is a variable capacitor 119 to facilitate tuning of the system's frequency.

The primary coil L1 and primary resonator coils L21-L24 can include wires or conductive foil strips that are applied to a surface of the cage unit 110. An insulating tape (not shown) can be applied to the foil strip to isolate coils electrically from each other. In one embodiment, the coils may be disposed within the cage unit 110; in another embodiment, the coils may be disposed outside of the cage unit 110; and in yet another embodiment, the coils may be embedded within the plastic walls of the cage unit 110.

In one embodiment, the control unit 120 includes a personal area network transceiver unit 126 (such as a system conforming to the Bluetooth Low Energy (BLE) standard) and a local area network (e.g., WiFi) transceiver unit 128. These units communicate with a DC-DC converter 124, which receives control data from the local area network transceiver unit 128 and generates a direct current (DC) power level signal in response thereto. A power amplifier 122 generates a radio frequency (RF) power signal in response to the DC power level signal and the RF power signal drives the primary coil L1. In one embodiment, the control unit 120 can include a Beagle Bone Black (BBB) or Raspberry Pi (RPi) system. The controller, which is like a small and low cost computer, dynamically adjusts the delivered power level by controlling a DC-DC converter that provides the variable supply voltage for a Class-C power amplifier (PA). The controller receives feedback from the headstage via Bluetooth link about the amount of received power at the headstage (in this case the rectifier output voltage). The controller uses this information to close the power control loop by setting the PA supply voltage and RF output power at a level that is barely enough to keep the headstage functional, which prevents waste of power in the headstage and overheating in the PA or primary and secondary coils.

A headstage unit 130 is physically coupled to the animal 10. The headstage unit 130 receives power from wireless power transfer signal from the primary resonator coils L21-L24 and communicates data wirelessly from a sensor associated with the animal 10 to a wireless personal area network. The headstage unit 130 includes a headstage secondary resonator coil L3 that is magnetically coupled to at least one of the primary resonator coils L21-L24. A headstage power coil L4 is responsive to resonance in the headstage secondary resonator coil L3. A circuit 132 harvests power from the headstage power coil L4. While the headstage unit 130 is shown affixed to the animal's head, it can be affixed to other parts of the animal, depending on the specific experiment being performed. The headstage unit 130 can include many different types of devices used in experiments. The headstage unit 130 can be used both for collecting data from the animal and for interacting with the animal by, for example, stimulating the animal or administering medications to the animal. A few examples include: a neural implant (or other type of implant) that senses neural potential data from the animal; a stimulation circuit that is configured to apply stimulation to the animal; a physiological parameter sensor; a behavior tracking sensor; a position sensor; and a remotely-controlled medication pump. In one embodiment, the system includes a closed-loop power control mechanism that receives a feedback signal indicative of wireless power received by the headstage unit 130 and that adjusts power output to ensure that the headstage unit 130 receives stable power irrespective of animal movements.

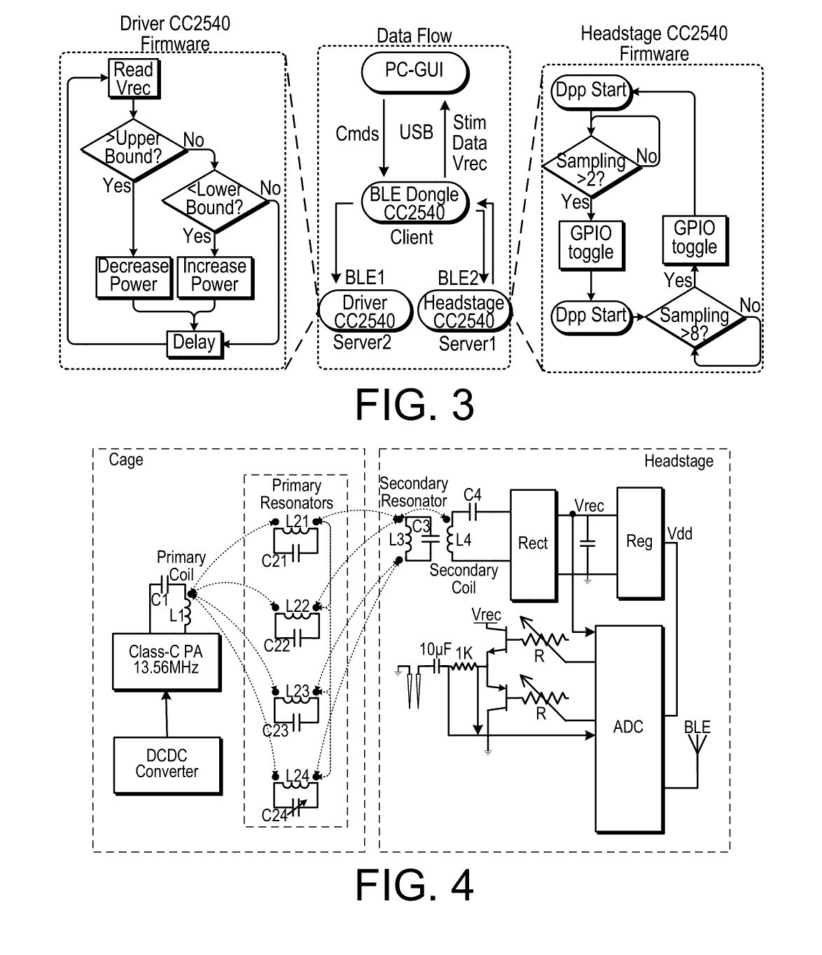

One representative embodiment of a method for controlling power level to the headstage is shown in FIG. 3 and one representative embodiment of an equivalent circuit to the cage unit and the headstage is shown in FIG. 4.

The system can be employed to equip a rack of cages to be smart (fully-automated) for wirelessly interfacing with the animal head-mounted devices utilized for physiological data collection on a continuous basis and maintain it over an extended period of time with minimal operator involvement to allow enriched environments equipped with the necessary instruments and tools for the most popular animal species in behavioral neuroscience, i.e. the rodents.

The system focuses the transmitter power over the location of the receiver and does not need any switching circuitries to control the resonators on the transmitter side. Interference between adjacent cage units can be reduced when there is a gap more than 10 cm between them. The system can automatically adjust of the level of the received power via a closed-loop power control mechanism using wireless data link, such as Bluetooth, and embedded systems, such as Beagle Bone Black (BBB) and Raspberry Pi (RPi). A central computer can control multiple cage units to gather recorded data in high throughput experiments. The close loop power control mechanism can use, for example, a Bluetooth data link to transfer feedback data that is related to the received power level between the headstage or implant on the animal body to the embedded system (BBB/RPi) through a wireless microcontroller, such as a CC2541. As will be well appreciated to those of skill in the data communication art, other types of data link systems may be employed without departing from the scope of the invention.

One experimental embodiment of a high throughput multi-cage system employs N (1<N<65) cage unit systems operating in parallel while a central PC communicates with the individual controllers to set operating conditions and collect all the data gathered by individual systems. The central PC can be connected to the BBBs via Ethernet cables and a hub. In other embodiments, the central PC is connected to the RPis wirelessly via WiFi connection. The cage system employs geometrically-optimized array of overlapping segmented resonator coils (in this case four coils, L21-L24) which encompass the homecage. There is no need to switch the transmitter resonators or transmitter coil for localizing the transmitted power at the location of the receiver (headstage) because the RF power automatically flows through strongest couplings between the secondary receiver coils and the primary resonators. A rectangular-shaped wire-wound coil (L1) as a primary resonator at the bottom of the homecage, which is the only coil that is actively driven by a class-C PA. The system employs secondary resonator (L3) and secondary receiver coils (L4) as the power receiver that together with primary homecage coils to establish a 4-coil inductive power transmission link, which provides high PTE regardless of the animal (i.e. the headstage) position within the homecage.

In one embodiment, the coils can include: rigid wire (such as with a diameter of 1.6 mm); two-segment copper foil (width of 13 mm); and four-segment copper foil (width of 25 mm). The operating frequency of all the homecages in this embodiment can be tuned at 13.56 MHz.

The segmentation method can be applied to the primary resonators (L21-L24) to make sure the perimeter of the primary resonator loop (Pr) is less than the effective wavelength (Pr<λ_{eff}) of the target operating frequency to optimize the power transfer efficiency (PTE) and PDL. As f=13.56 MHz, the wavelength equals 13 m (λ=3×10⁸/(f×√εᵣ)), and the effective wavelength would be 1.3 m (λ_{eff}=/10). The perimeters of the primary resonators L21-L24 in certain experimental homecage prototypes are 1.1 m, 1.3 m, 1.1 m, and 1.3 m, respectively. Thus, the Tx resonators were segmented only by two to make sure the segmentation rule (Pr<λ_{eff}) is satisfied. Higher PTE can be achieved using copper foil primary resonators with the width of 25 mm because of its higher quality factor (118) compared to the rigid wire with 1.6 mm diameter (Q=105) and copper foil with the width of 13 mm (Q=114).

It has been found experimentally that the interference between adjacent homecages would be at a desired level when there is at least 10 cm separation between them. In a current experimental design, only one of the four transmitter resonators (L21-L24) needs to include a variable capacitor that is used to fine-tune the resonance frequency of the entire homecage on the transmitting side.

In one experimental embodiment, the received power was measured of 45 mW at the center of the homecage at a height of 7 cm, i.e. (0,0,7) cm coordinates in the 3D space, with the receiver resonator (L3) that had a diameter of 2.2 cm. As shown in FIG. 9, a 3D plot demonstrates measured power transfer efficiency (PTE) of the WPT link across the homecage for segmented vs. loop primary resonators at 13.56 MHz, while the receiver, including the secondary resonator (L3) and receiver coil (L4) were swept along x and y axes, at a height of 7 cm from the bottom of the homecage. This graph presents the measured PTE when the system is open-loop to demonstrate the uniformity of the PTE across the homecage. This result shows that a considerably larger PTE is obtained with segmented resonators compared to the loop resonators, particularly when the receiver moves close to the homecage walls, where the primary resonators (L21-L24) are located. The average measured PTE across the entire homecage at 7 cm was about 12%, while the load resistor across L4C4-tank was 100 Ohm.

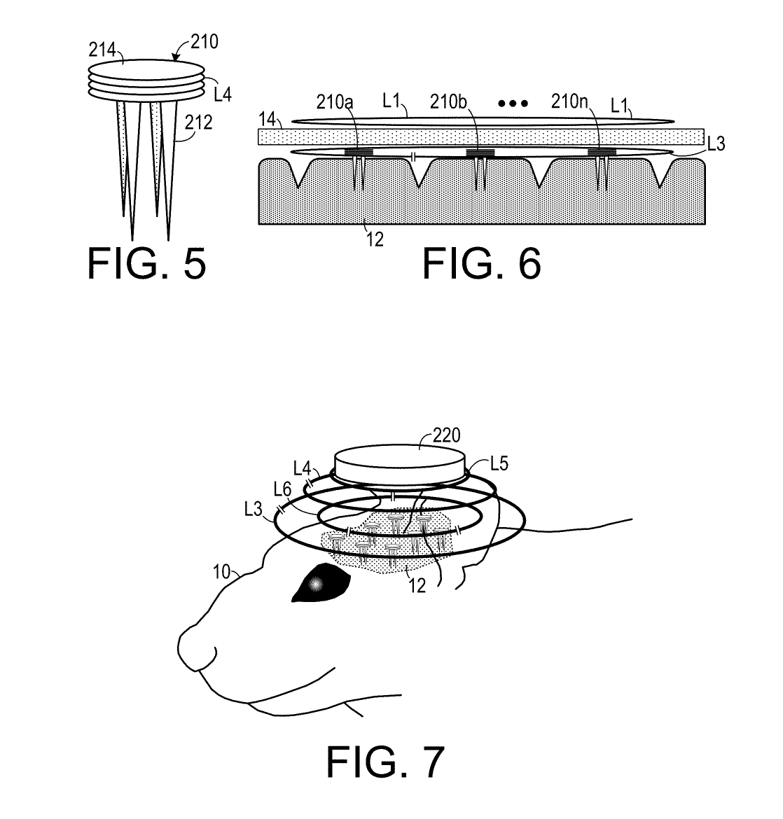

As shown in FIG. 5, a wirelessly-powered floating implant 210 may be used to collect data. The implant 210 includes an electrode(s) portion 212 that is configured to be implanted into tissue (such as neural tissue, in one embodiment), which is powered by a coil system 214 employing receiver coils L4. In one embodiment, as shown in FIG. 6, a plurality of implants 210a-210n can be implanted in, for example, brain tissue 12 (such as the cerebral cortex) of a subject 10. A segmented resonator coil L3 can be placed under the skull 14 and power coil L1 can be placed outside of the skull 14, and even outside of the skin, to induce resonance in the segmented resonator coil L3, which results in power being delivered to the floating implant 210.

In the distributed implant architecture shown in FIG. 6, the wireless free-floating probes 210a-210n can be inserted on the surface of the brain like pushpins, targeting desired regions of the cortex at the desired depth, which is indicated by the length of the electrode 212. The electrodes 212 can be made of metal wires, and the probes 210 can be wirelessly operated by an external transceiver from outside the cranium across the skull bone 14 and the scalp (not shown). The free-floating implants employ implanted high-Q resonators that encompass the small implants in more or less the same plane. An array of transmitter coils, represented by L1, from outside of the body (on the scalp in this scenario) delivers power to multiple free-floating small receiver coils L4 through a high-Q implanted resonator (L3) that encompasses all the small coils in the same plane on the surface of the brain. Small mm-sized coils tend to have their optimal Q-factor at >100 MHz. In one experimental design, the carrier frequency was selected at 207 MHz to keep the efficiency at the highest possible level.

The fact that an added high-Q resonator can improve the PTE when it is placed around small coils in the same plane, offers the opportunity for powering the distributed free-floating 1-mm sized implants in an area not just limited to the cortical tissue under an external coil but the size of a cage with the small 1-mm sized devices implanted in the freely behaving animal subjects. That will allow the use of small distributed stand-alone free-floating implants for recording the brain activities of small freely-behaving animals like rats and mice. Therefore, the present system can power up 1-mm sized implants in a relatively large area in the order of 20×20 cm². The 1-mm sized Rx coils (L4) can be implanted in the animal's (e.g., the rat's) head while the secondary resonator (L3) will be attached above the head in a headstage, not necessarily implanted, in a way that is its still encompassing the small implanted Rx coils.

The selected power carrier frequency in one experimental embodiment was within 100 MHz-300 MHz band, in this case, 207 MHz The perimeter of the transmitting coil and secondary resonator were smaller than the effective wavelength (λ/10, while λ=3×10⁸/(f×√εᵣ)). A 4-coil inductive link structure was utilized to implement the homecage. The 4-coil inductive link was found to have a better PTE than 3-coil inductive link for powering the receiver at larger distance.

To design a large but high frequency transmitter coils for the homecage, the perimeter of the primary coil (L1) and primary resonator (L2) are larger than the effective wavelength. Therefore, these transmitter coils need to be segmented by a certain of capacitors in between to form the high frequency LC-tanks in the 100-300 MHz range. One experimental embodiment used 3 and 4 segments for the primary coil (L1) and primary resonator (L2), respectively, to make sure that each segment's length is less than effective wavelength.

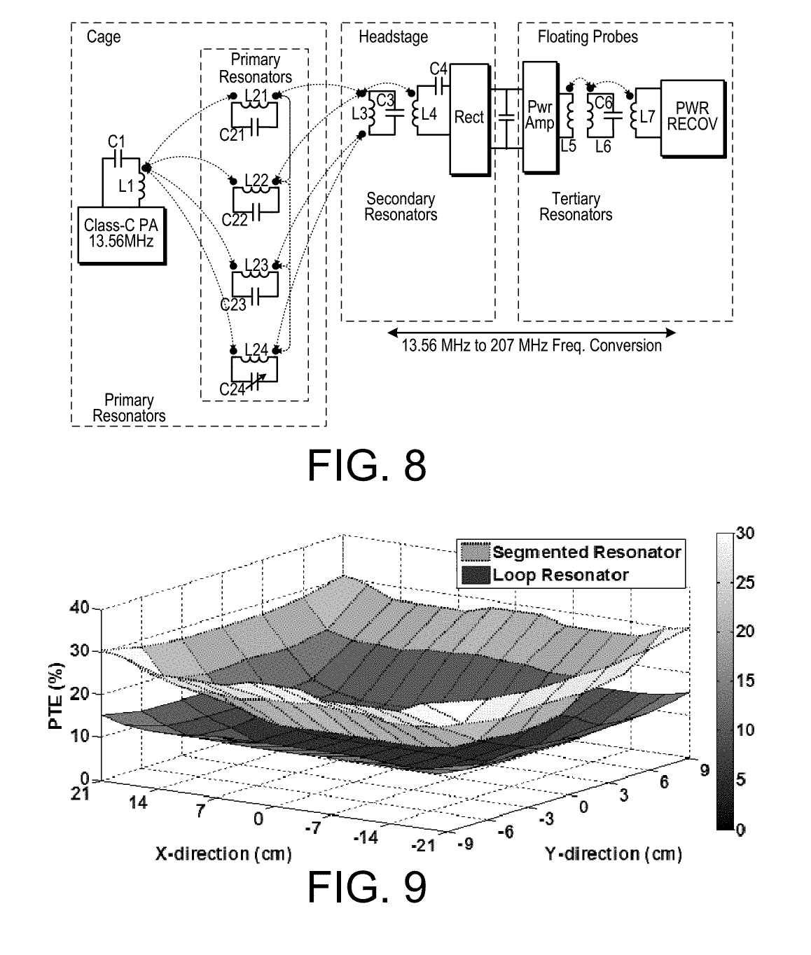

One example of a dual-band headstage system is shown in FIG. 7 and an equivalent circuit is shown in FIG. 8. The dual-band homecage can continuously power up the headstage in the near-field regime at the FCC-approved 13.56 MHz in the industrial, scientific, and medical (ISM) band by automatically focusing the field in the position of the headstage (on the animal head) and reducing the risk of interference with nearby instruments or excessive exposure to the animal subject or the research personnel. The headstage electronics 220 rectify, up-convert, and retransmit the received power through a full-wave rectifier and class-E power amplifier (PA), both of which are quite efficient at >80% and >90% power conversion efficiencies (PCE). The headstage then retransmits the received power at >100 MHz (e.g. 207 MHz) to power up the floating probes, which is far more efficient for mm-sized coils than lower carrier frequencies, using a 3-coil link. In this way, the headstage is relaying on the wireless power from the homecage to power the floating probes using optimal carrier frequencies across each of the two inductive link bottlenecks. This method could be safer, more power efficient, and more suitable for larger spaces, the size of a standard homecage, than high frequency power transmission, which can face regulatory barriers because of the potential interference and lower safety limits. By taking advantage of multiple overlapping coils, only one driver would be needed to deliver power through all five primary coils. This can help reduce the size, cost, and power consumption of the system.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A homecage system for facilitating an experiment using an animal, comprising:
(a) a cage unit configured to hold the animal therein;
(b) a misalignment insensitive transmitting resonant wireless power transfer unit encompassing the cage unit, the transmitting resonant wireless power transfer unit configured to be driven by an external power signal so as to generate a radio frequency wireless power transfer signal;
(c) a headstage unit, configured to be physically coupled to the animal, that is responsive to the wireless power transfer signal and that transmits data wirelessly from a sensor associated with the animal;
(d) a control unit in data communication with the headstage unit and that controls the external power signal; and
(e) a remote unit in data communication with the control unit that transmits control information thereto and that communicates data via a local area network.

2. The homecage system of claim 1, wherein the headstage unit communicates with the control unit via a wireless personal area network.

3. The homecage system of claim 2, wherein the wireless personal area network comprises a low energy standard wireless personal area network.

4. The homecage system of claim 1, further comprising a closed-loop power control mechanism that receives a feedback signal indicative of wireless power received by the headstage unit and that adjusts power output by the misalignment insensitive transmitting resonant wireless power transfer unit in response thereto, thereby ensuring that the headstage unit receives stable power irrespective of animal movements.

5. The homecage system of claim 4, wherein the remote unit transmits control information to the control unit via a wireless local area network.

6. The homecage system of claim 1, wherein the misalignment insensitive transmitting resonant wireless power transfer unit comprises:
(a) a primary coil, having a resonant radio frequency, directly driven by the control unit so as to oscillate at the resonant radio frequency; and
(b) a plurality of primary resonator coils that are electrically isolated from the primary coil and from each other, the plurality of primary resonator coils in magnetic resonance with the primary coil, each of the plurality of primary resonator coils affixed to a portion of the cage unit and aligned along a different plane so that no two of the plurality of primary resonator coils are co-planar.

7. The homecage system of claim 6, wherein the headstage unit comprises:
(a) a headstage secondary resonator coil that is magnetically coupled to at least one of the primary resonator coils;
(b) a headstage power coil that is responsive to resonance in the headstage secondary resonator coil; and
(c) a circuit configured to harvest power from the headstage power coil.

8. The homecage system of claim 6, wherein each of the plurality of primary resonator coils comprises:
(a) a conductive member having a first end and an opposite second end; and
(b) a terminating capacitor coupling the first end to the second end.

9. The homecage system of claim 8, wherein at least one terminating capacitor is a variable capacitor.

10. The homecage system of claim 6, wherein each of the plurality of primary resonator coils comprises:
(a) a conductive foil strip applied to a surface of the cage unit; and
(b) an insulating tape applied to the foil strip.

11. The homecage system of claim 6, wherein the control unit comprises:
(a) a personal area network transceiver unit;
(b) a local area network transceiver unit;
(c) a converter unit that receives control data from the local area network transceiver unit and that generates a direct current (DC) power level signal in response thereto; and
(d) a power amplifier that generates a radio frequency (RF) power signal in response to the DC power level signal, wherein the RF power signal drives the primary coil.

12. The homecage system of claim 1, wherein the headstage unit comprises at least one device selected from a list consisting of: a neural implant that senses neural potential data from the animal; a stimulation circuit that is configured to apply a stimulation to the animal; a physiological parameter sensor; a behavior tracking sensor; a position sensor; and a remotely-controlled medication pump.

13. A homecage, comprising:
(a) a cage unit configured to hold the animal therein;
(b) a misalignment insensitive transmitting resonant wireless power transfer unit encompassing the cage unit, the transmitting resonant wireless power transfer unit configured to be driven by an external power signal so as to generate a wireless power transfer signal, the misalignment insensitive transmitting resonant wireless power transfer unit including:
(i) a primary coil, having a resonant radio frequency, directly driven by the control unit so as to oscillate at the resonant radio frequency; and
(c) a plurality of primary resonator coils that are electrically isolated from the primary coil and that are in magnetic resonance with the primary coil, each of the plurality of primary resonator coils affixed to a portion of the cage unit and aligned with a different plane so that no two of the plurality of primary resonator coils are co-planar; a control unit that controls the external power signal.

14. The home cage of claim 13, wherein each of the plurality of primary resonator coils comprises:
(a) a conductive member having a first end and an opposite second end; and
(b) a terminating capacitor coupling the first end to the second end.

15. The home cage of claim 14, wherein at least one terminating capacitor is a variable capacitor.

16. A method of controlling an experiment with an animal, comprising the steps of:
(a) affixing a headstage unit to the animal and placing the animal in a cage;
(b) powering the headstage unit with a misalignment insensitive transmitting resonant wireless power transfer unit that encompasses the cage; and
(c) collecting data from the headstage unit with a wireless device.

17. The method of claim 16, wherein the step of powering the headstage unit comprises the steps of:
(a) driving a primary coil, having a resonant frequency, underneath the cage with a power signal that oscillates at the resonant frequency;
(b) inducing magnetic resonance with the primary coil in at least one of a plurality of primary resonator coils encompassing the cage unit, each of which is aligned along a different plane;
(c) inducing magnetic resonance with at least one of the plurality of primary resonator coils in a headstage secondary resonator coil; and
(d) inducing resonance in a headstage secondary power coil from the headstage secondary resonator coil; and
(e) harvesting power from the headstage secondary power coil.

18. The method of claim 16, wherein the step of collecting data from the headstage unit with a wireless device comprises receiving data from the headstage unit via a wireless local area network.

19. The method of claim 18, wherein the data includes feedback information indicative of power applied to the headstage unit and further comprising the step of adjusting power output by the misalignment insensitive transmitting resonant wireless power transfer unit in response to the feedback information.

20. The method of claim 16, further comprising the step of receiving data from at least one sensor, the sensor being at least one of: installed around an experimental arena; attached to the animal's body; and implanted in the animal's body.
